(19) United States
(12) Patent Application Publication
(10) Pub. No.: US 2004/0061717 A1
(43) Pub. Date: Apr. 1, 2004

(54) Mechanism for voice-enabling legacy internet content for use with multi-modal browsers

(76) Inventors: Rama R. Menon, Portland, OR (US); Ramesh G. Illikkal, Portland, OR (US); Uma G. Ilango, Beaverton, OR (US); Burzin A. Daruwala, Hillsboro, OR (US)

Correspondence Address: MARGER JOHNSON & MCCOLLOM PC, 1030 SW MORRISON STREET, PORTLAND, OR, 97205, US

(21) Appl. No.: 10/262,595

(22) Filed: Sep. 30, 2002

(51) Int. Cl. G09G 5/00

(52) U.S. Cl. 345/727; 345/748; 345/738; 345/744

(57) ABSTRACT

The invention is a multi-modal browsing system and method. The modes of the client and content are determined. An intelligent content processor may translate content from one mode to another to provide the client with a multi-modal browsing experience.

### FIELD

This invention pertains to networks, and more particularly to providing multi-modal content across a network.

### BACKGROUND

When computers were only within the reach of major corporations, universities, and governmental entities, networks within these institutions began. These early networks consisted of dumb terminals connected to a central mainframe. The monitors of the dumb terminals typically were monochrome and textual only. That is, the dumb terminals did not offer color or graphics to users.

Networks also developed that connected these institutions. The predecessor of the Internet was a project begun by the Defense Advanced Research Projects Agency (DARPA), within the Department of Defense of the United States government. By networking together a number of computers at different locations (thereby eliminating the concept of a network “center”), the network was safe against a nuclear attack. As with mainframe-centered networks, the original DARPA network was text-based.

As computers developed, they became within the reach of ordinary people. And as time passed, technology improved, giving better computer experiences to users. Early personal computers, like dumb terminals before them, included monitors that were monochrome and textual only. Eventually, color monitors were introduced, along with monitors capable of displaying graphics. Today, it is rare to find a terminal or personal computer that includes a monochrome or text-only monitor.

Network capabilities also improved, in parallel with the growth of the computer. While the original versions of Internet browsers were text-based hyper-linking tools (such as Lynx and Gopher), the introduction of Mosaic “brought” graphics to the Internet browsing experience. And today, more and more web sites are including music along with graphics and text (even though the music is more of an afterthought than integrated into the browsing experience).

In parallel with the rise of the personal computer (although shifted somewhat in time), other technologies have developed. The cellular telephone and the Personal Digital Assistant (PDA) are two examples of such technologies. Where the technology in question enables interaction using a different “toolset,” the technology is said to use a different mode. For example, the personal computer supports text and graphics, a different mode from voice interaction as offered by a voice-response system via a cellular telephone.

Looking back in time from today, it seemed inevitable that these technologies would start to consolidate. But consolidation of technologies is not a simple thing. FIG. 1 shows a devices connecting to a network according to the prior art. At the present time, computer system 105, cellular telephone 110, and PDA 115 have slowly become able to connect to the same network 120. But each device connects to different content. For example, server 125 may offer content 130 that includes a mix of text and graphics designed for display on monitor 145 of computer system 105. Viewing content 130 on a device for which it was not designed may be difficult (PDA 115 may not provide sufficient screen area to effectively present the entirety of content 130) or impossible (cellular telephone 110 is incapable of displaying either text or graphics at all).

One client may have plenty of memory, processing power (powerful CPU) and have broadband connectivity, while another may have limited resources (CPU, memory and bandwidth). Some clients have limited “display” area, like those in PDAs, whereas other clients have generous display areas, like desktop/laptop computers. All of these factors/characteristics of clients necessitate that content be delivered in an appropriate format that is suited for each client.

Thus, content today needs to be created and stored in multiple formats/quality levels, in order to satisfy the needs of the variety of clients consuming this content over a variety of network connections. This leads to replication as well as sub-optimal representation/storage of original content at the server.

### BRIEF DESCRIPTION OF THE DRAWINGS

FIG. 1 shows devices communicating across a network according to the prior art.

FIG. 2 shows the devices of FIG. 1 communicating across a network using an intelligent content processor, according to an embodiment of the invention.

FIGS. 3A-3D show the intelligent content processor of FIG. 2 managing communications between legacy and rich clients and legacy and rich contents, according to an embodiment of the invention.

FIG. 4A shows the intelligent content processor of FIG. 2 included within a router, according to an embodiment of the invention.

FIG. 4B shows the intelligent content processor of FIG. 4A updating a list of modes supported by the client of FIG. 4A, according to an embodiment of the invention.

FIG. 5A shows the intelligent content processor of FIG. 2 included within a service provider, according to an embodiment of the invention.

FIG. 5B shows the intelligent content processor of FIG. 5A updating a list of modes supported by the client of FIG. 5A, according to an embodiment of the invention.

FIG. 6 shows the intelligent content processor of FIG. 2 providing content to the client of FIG. 2 in multiple modes, according to an embodiment of the invention.

FIG. 7 shows the intelligent content processor of FIG. 2 separating content into two modes and synchronizing delivery to two different devices, according to an embodiment of the invention.

FIG. 8 shows the intelligent content processor of FIG. 2 translating data provided by the client of FIG. 2 into a different mode for the source of the content, according to an embodiment of the invention.

FIG. 9 shows the intelligent content processor of FIG. 2 translating content between different modes for legacy devices, according to embodiments of the invention.

FIGS. 10A-10B show a flowchart of the procedure used by the intelligent content processor of FIG. 2 to facilitate using multiple modes, according to an embodiment of the invention.

FIG. 11 shows a flowchart of the procedure used by the intelligent content processor of FIG. 2 to filter and/or translate content between modes, according to an embodiment of the invention.

### DETAILED DESCRIPTION

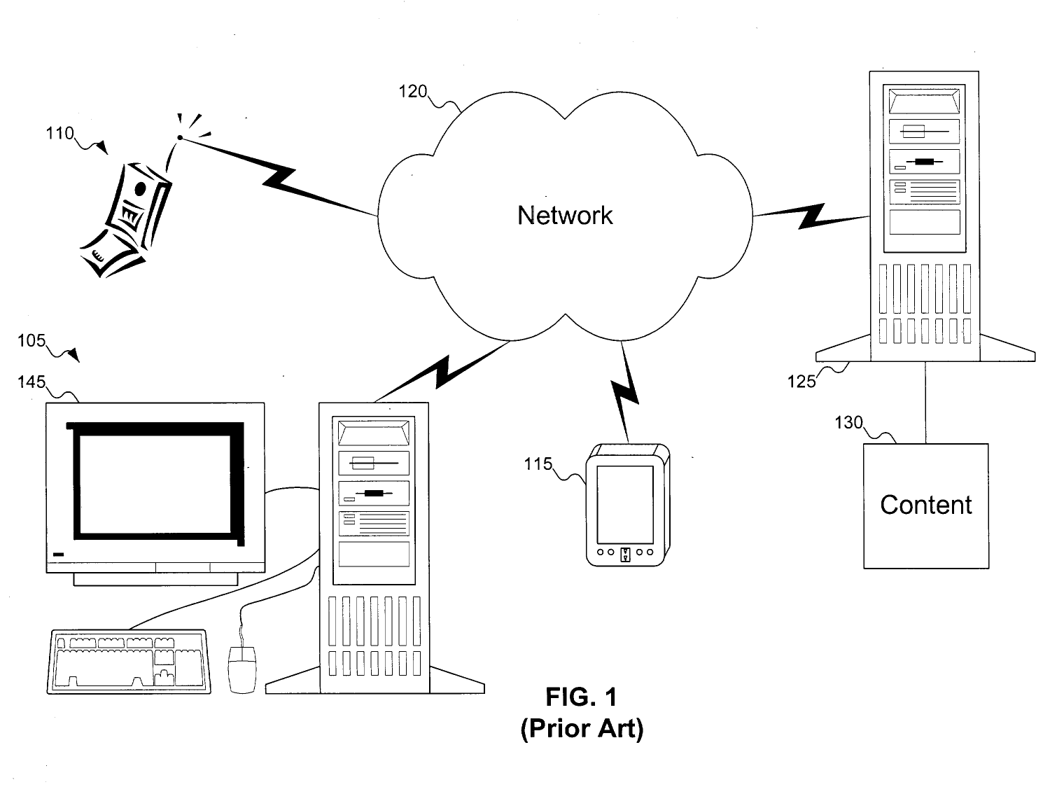

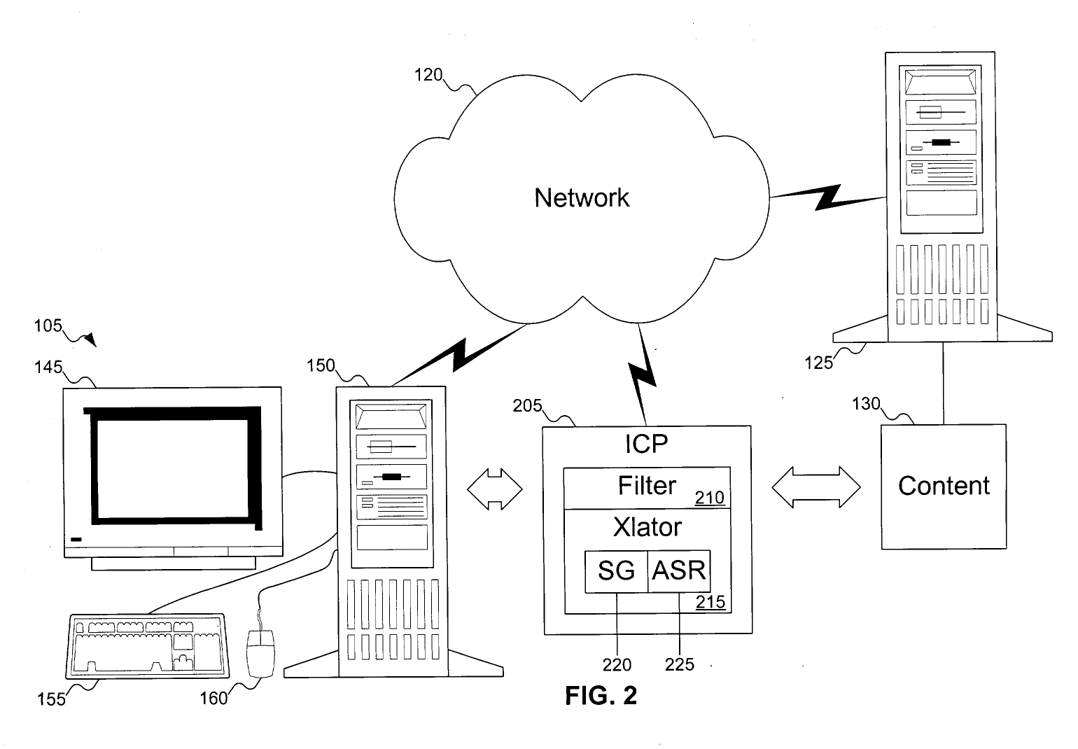

FIG. 2 shows the computer system of FIG. 1 communicating across a network using an intelligent content processor, according to an embodiment of the invention. In FIG. 2, only computer system 105 is shown connecting to network 120, but a person skilled in the art will recognize that cellular telephone 110 and Personal Digital Assistant (PDA) 115 from FIG. 1 may also be used to take advantage of an embodiment of the invention. In FIG. 2, aside from monitor 145, computer system 105 includes computer 150, keyboard 155, and mouse 160. But a person skilled in the art will recognize that computer system 105 may be any variety of computer or computing device capable of interacting with a network. For example, computer system 105 might be a notebook computer, an Internet appliance, or any other device capable of interacting with a server across a network. Similarly, network 120 may be any type of network: local area network (LAN), wide area network (WAN), global network, wireless network, telephony network, satellite network, or radio network, to name a few.

Instead of communicating directly with server 125, computer system 105 communicates with intelligent content processor 205, which in turn communicates with server 125. As will be explained below, intelligent content processor 205 is responsible for determining the mode(s) supported by a particular device, determining the mode(s) in which content 130 is offered, and if necessary, filtering or transforming the content from one mode to another.

To perform its task, intelligent content processor 205 includes two components: filter 210 and translator 215. Filter 210 is responsible for filtering out content that may not be translated to a mode supported by the client. Translator 215 is responsible for translating content between modes. To achieve this, translator 215 includes two sub-components: text to speech module 220 and automatic speech recognition system 225. Text to speech module 220 takes text from content 130 and produces vocalizations that the user may hear. Automatic speech recognition system 225 takes words spoken by the user and translates them back to text. (Note that in this document, the term “client” is not limited to a single device, but includes all devices which a user may use to access or receive content. Thus, if computer system 105, cellular telephone 110, and PDA 115 are all owned by the same user, they are all considered part of a single client.)

Although translator 215 is shown as including only text to speech module 220 and automatic speech recognition system 225, a person skilled in the art will recognize that translator 215 may include other sub-components. For example, if networks become able to support the transmission of odors, translator 215 might include a component to translate a picture of a cake into the aroma the cake would produce.

Although eventually it may happen that content will be offered in every possible mode, and devices will support multiple modes, at this time such is not the case. An additional factor to be considered is the “bandwidth” factor. That is, different clients may connect to the server/intelligent content processor with different network connection throughputs/bandwidths. This in turn may necessitate content transformation, even for the same modes. For example, a server might host content with audio encoded at 128 kbps, while the connection to a client that might receive audio at 56 Kbps. This necessitates that the audio content be coded to a lower bit rate by the intelligent content processor.

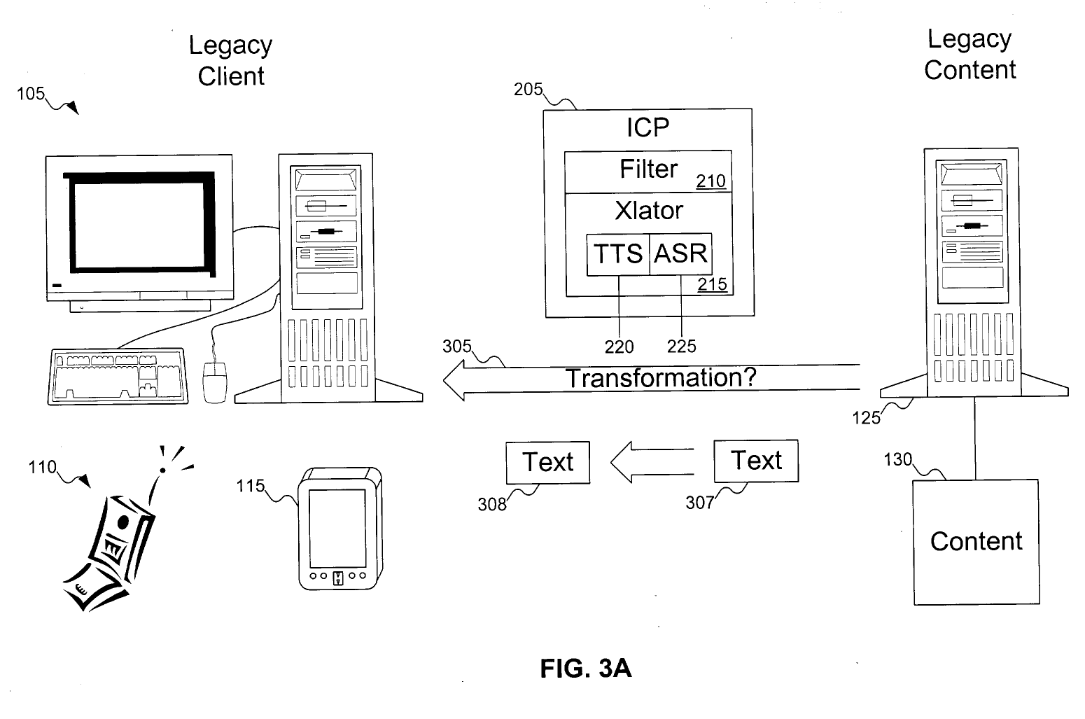

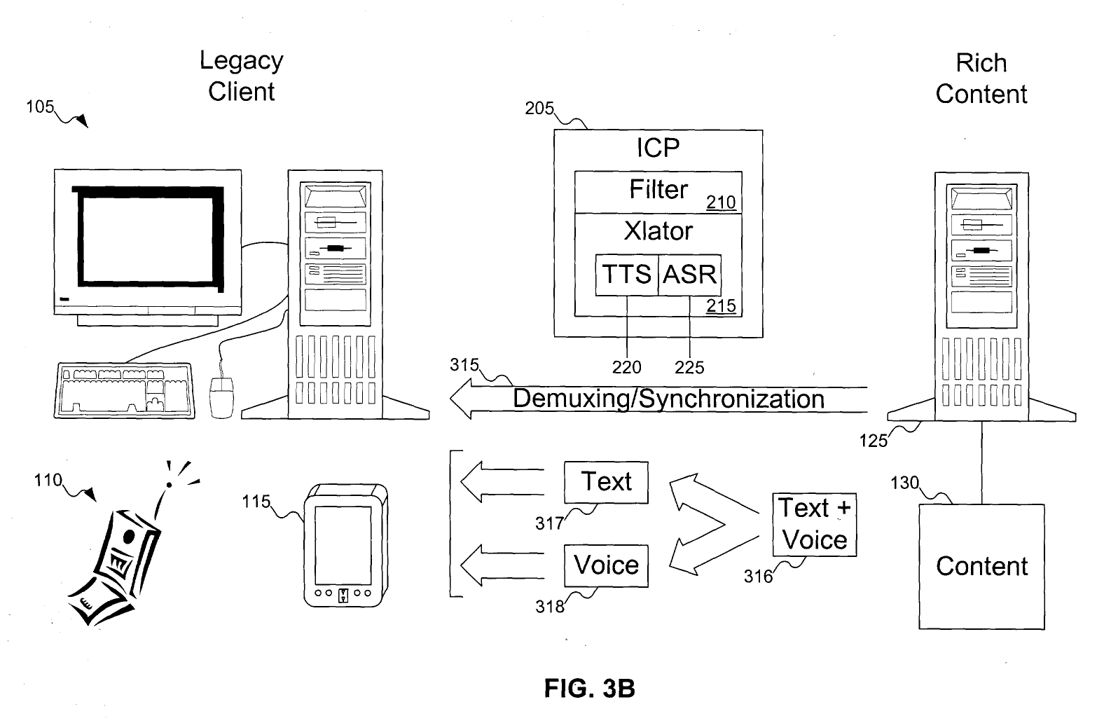

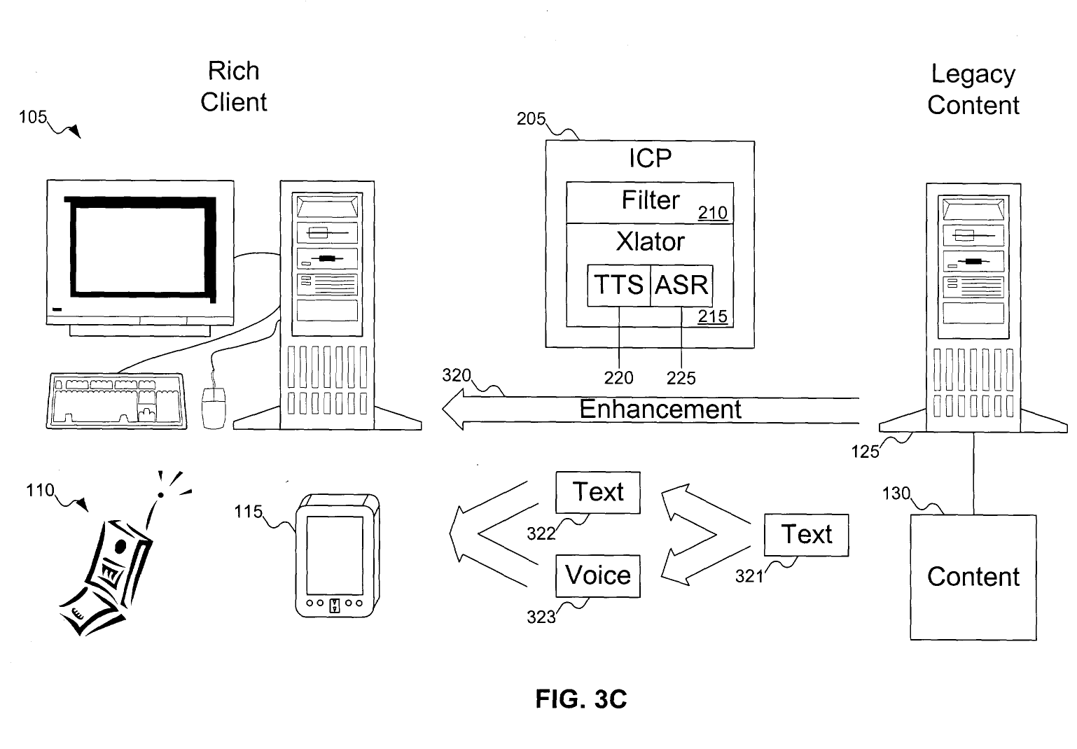

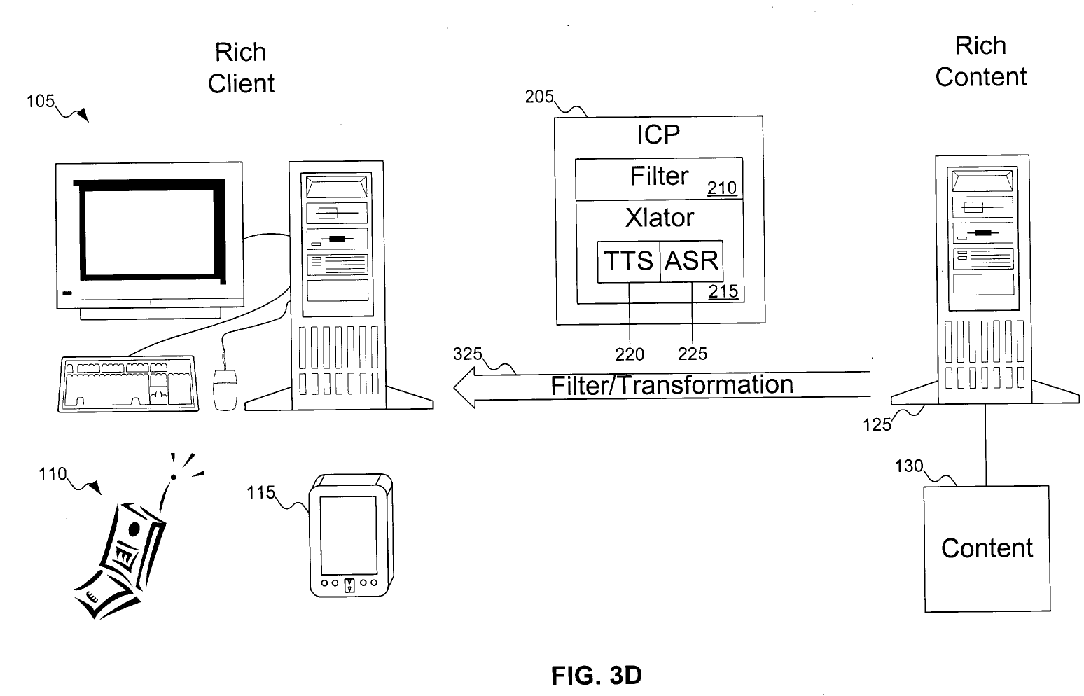

And even if the time arrives where content and interaction will both support multiple modes, it may still be necessary to manage the transformation of data between modes. Thus, there are two types of clients and two different types of content. There are both legacy and rich clients (that is, clients that support on individual modes and clients that support multiple modes), and there are both legacy and rich content (that is, content in a single mode and content in multiple modes). FIGS. 3A-3D show the intelligent content processor of FIG. 2 managing communications between legacy and rich clients and legacy and rich contents, according to an embodiment of the invention.

An advantage of using intelligent content processor 205 is that there is no need for different versions of the same content to be authored/created/stored/maintained on the content server. Thus, content preparation/publishing/management tasks are much simpler: only one version of the content need be maintained, potentially just in the highest “resolution”/quality level (richest representation) on the server. Intelligent content processor 205 takes care of adapting the content to match the capabilities of the clients as well as their connectivity characteristics.

In FIG. 3A, intelligent content processor 205 is shown connecting a legacy client with a legacy content. In this situation, there are two possibilities: either the content and the client both support the same mode (e.g., both are voice data, or both are text/graphics data), or the content and the client support different modes. If the content and the client are in the same mode, then intelligent content processor 205 need do nothing more than transmit content 130 to the client (be it computer system 105, cellular telephone 110, PDA 115, or any other device). (Note, however, that even when the content and the client support the same mode, intelligent content processor 205 may need to filter the content to a level supported by the client. This filtering operation may be performed by intelligent content processor 205 regardless of the type of content or the type of client. This, in fact, brings out the effect of the “bandwidth” factor discussed earlier.) If the content and client are in different modes, then intelligent content processor 205 is responsible for transforming the content from the original mode to one supported by the client. For example, text data 307 is shown being transformed to text data 308 (perhaps translated from one language to another), which may then be displayed to a user, perhaps on the monitor of computer system 105, perhaps on PDA 115, or perhaps on another device. A person skilled in the art will recognize that other types of transformations are possible: for example, translation from voice data to text data or mapping text from a large display to a small display.

In FIG. 3B, the content is rich content, while the client is a legacy client. In this situation, the content supports multiple modes, while the client devices only support one mode. But since there may be more than one legacy device used by the client, the client may be able to support multi-modal content, by sending different content to different devices. Intelligent content processor 205 is responsible for managing the rich content. If the client devices only support one mode, then intelligent content processor 205 may either filter out the content that is in a mode not supported by the client, or else translate that content in a supported mode.

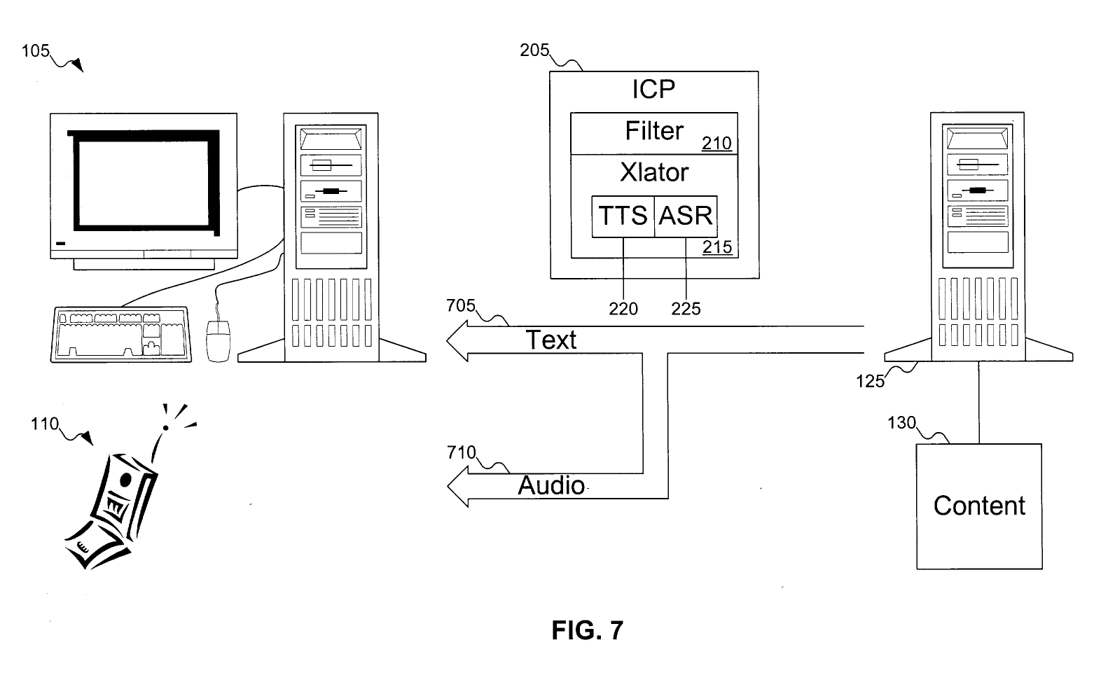

If the client devices support multiple modes (each device supporting only a single mode), then intelligent content processor 205 de-multiplexes the data into the separate modes, each supported by the different legacy devices of the client. (If necessary, intelligent content processor 205 may also transform data from one mode to another, and/or filter out data that may not be transformed.) Intelligent content processor 205 also synchronizes the data delivery to the respective legacy client devices. (Synchronization is discussed further with reference to FIG. 7 below.) For example, in FIG. 3B, text and voice data 316 is shown being de-multiplexed into text data 317 and voice data 318, which may then be separately sent to the monitor of computer system 105 and to cellular telephone 110, respectively.

In FIG. 3C, the client is a rich client, whereas the content is legacy content. If the rich client supports the mode in which the content is presented, then intelligent content processor 205 need do nothing more than act as a pass-through device for the content. Otherwise, intelligent content processor 205 transforms the content from the mode in which it is presented to a mode supported by the client. Note that since the client supports multiple modes in FIG. 3C (and also in FIG. 3D), intelligent content processor 205 may transform data into any mode supported by the client, and not just into one specific mode. For example, in FIG. 3C, text data 321 is shown being sent to the client device as text data 322 and being enhanced by voice data 323 (generated by text to speech module 220 from text data 321). Then, text data 322 and voice data 323 are combined for presentation on the rich client.

Finally, in FIG. 3D, both the client and the content are rich. If the content is in modes supported by the client and no further translation is needed, then intelligent content processor 205 acts as a pass-through device for the content. Otherwise, intelligent content processor 205 transforms the content to a mode supported by the client, or filters out content that is not in a client-supported mode and may not be transformed.

In FIGS. 3A-3D above, transforming the content may be accomplished in several ways. One way is to do a simple transformation. For example, where text is included in the content, the text may be routed through a speech generator, to produce spoken words, which may be played out to the user (e.g., through a speaker). A more intelligent transformation factors in the tags (such as Hyper-Text Markup Language (HTML) tags) used to build the content. For example, where there is a text input box into which a user may type information, if the user's device supports both audio in and audio out modes, the transformation may include aurally prompting the user to speak the input information.

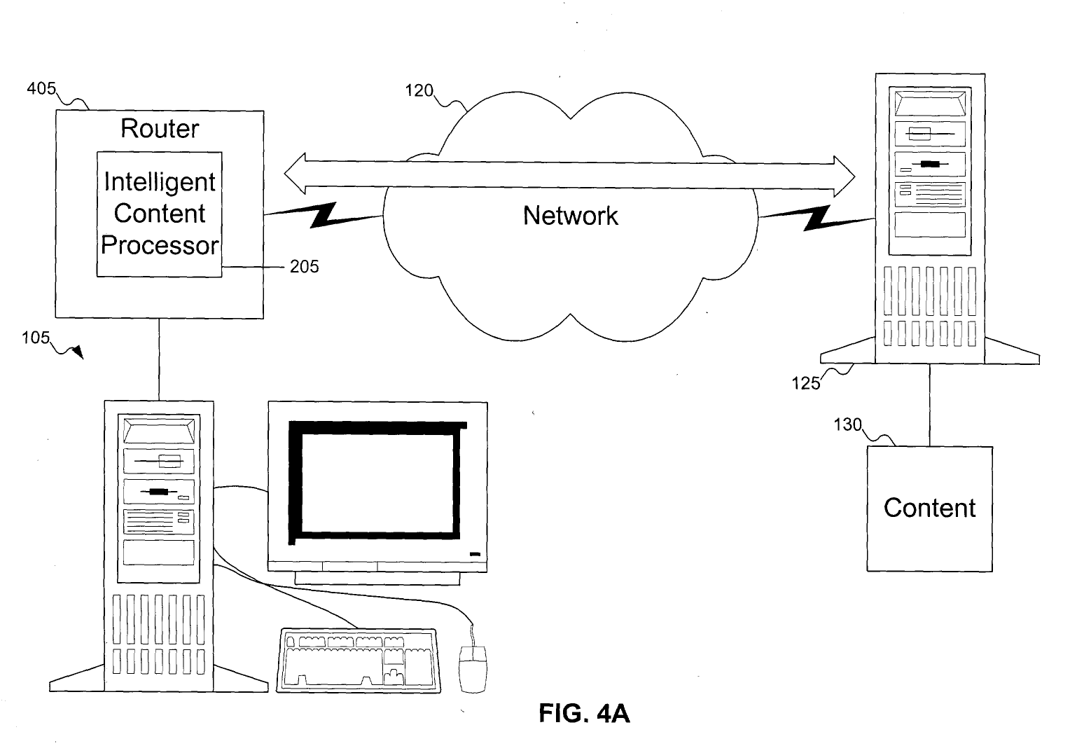

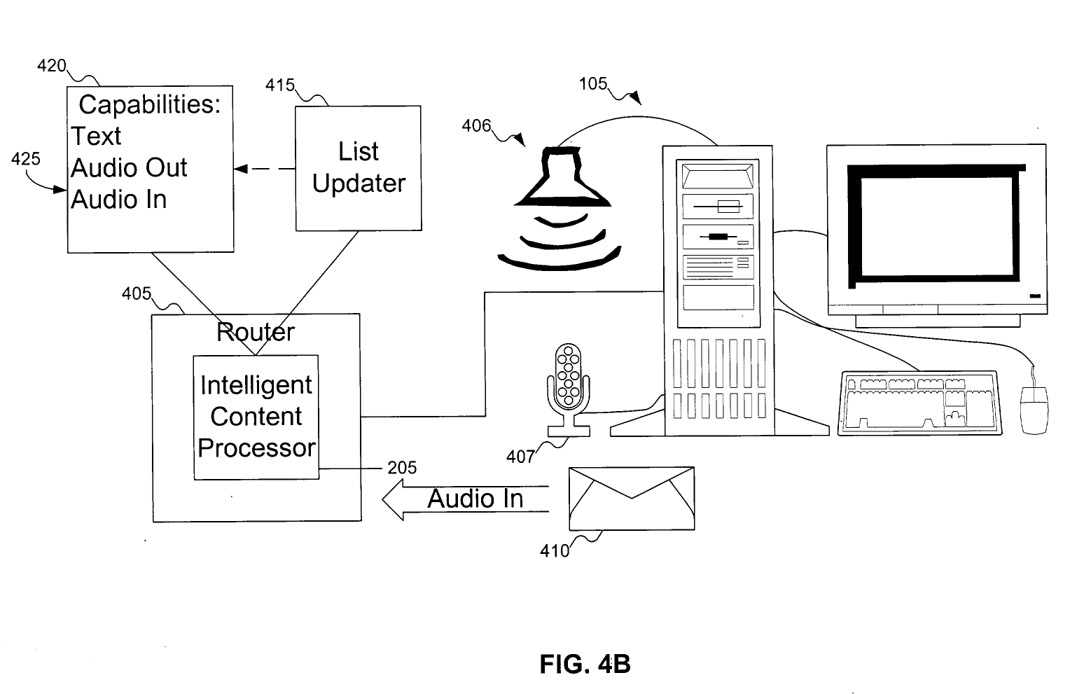

FIG. 4A shows the intelligent content processor of FIG. 2 included within a router, according to an embodiment of the invention. In FIG. 2, intelligent content processor 205 is simply somewhere on network 120. Individual clients, like computer system 105 (or administrator programs/agents on the clients' behalf), are responsible for getting the content in supported mode(s). In contrast, in FIG. 4 intelligent content processor 205 is specifically within router 405. A client need not know about the existence of the intelligent content processor 205; it simply is in the “path” to getting content and performs its function, transparent to the client. Including intelligent content processor 205 within router 405 allows a user to bring intelligent content processor 205 into a home network.

An advantage of placing intelligent content processor 205 within router 405 is that intelligent content processor 205 deals with a relatively stable client. Where intelligent content processor 205 is somewhere out on network 120 and deals with many clients, intelligent content processor 205 has to interrogate the client when the client first comes online to determine its capabilities, or have a similar function performed on its behalf by some other entity. A “discovery protocol” may be used that runs its components on the intelligent content processor 205 and on clients like computer system 105. When a new client is powered up or makes a network connection, this “discovery protocol” may be used to automatically update the list on intelligent content processor 205. (If clients have static Internet Protocol (IP) addresses, intelligent content processor 205 may at least store the modes associated with a particular IP address. But where clients are assigned dynamic IP addresses, such as for dial-up users, storing such a list becomes more complicated. The list may be achieved, for example, by using client names, using well-established standards to do <name, IP-addr> mapping.) But when intelligent content processor 205 deals with a stable list of clients, the capabilities of the clients change very little in the long term.

FIG. 4B shows the intelligent content processor of FIG. 4A updating a list of capabilities supported by the client of FIG. 4A, according to an embodiment of the invention. In FIG. 4B, the user has computer system 105, which includes speaker 406, and to which the user has added microphone 407, giving computer system 105 an “audio in” capability. (Another term for “client capability” used in this document is “mode.”) This information is relayed to intelligent content processor 205 as message 410 in any desired manner. For example, intelligent content processor 205 may be connected to computer system 105 using a Plug-and-Play type of connection, which ensures that both the computer and the attached device have the most current information about each other. In a similar manner, intelligent content processor 205 may be made aware of the loss of a supported capability.

Once intelligent content processor 205 has been alerted to a change in the supported modes, list updater 415 updates list 420 of supported modes. As shown by entry 425, list 420 now includes an “audio in” mode.

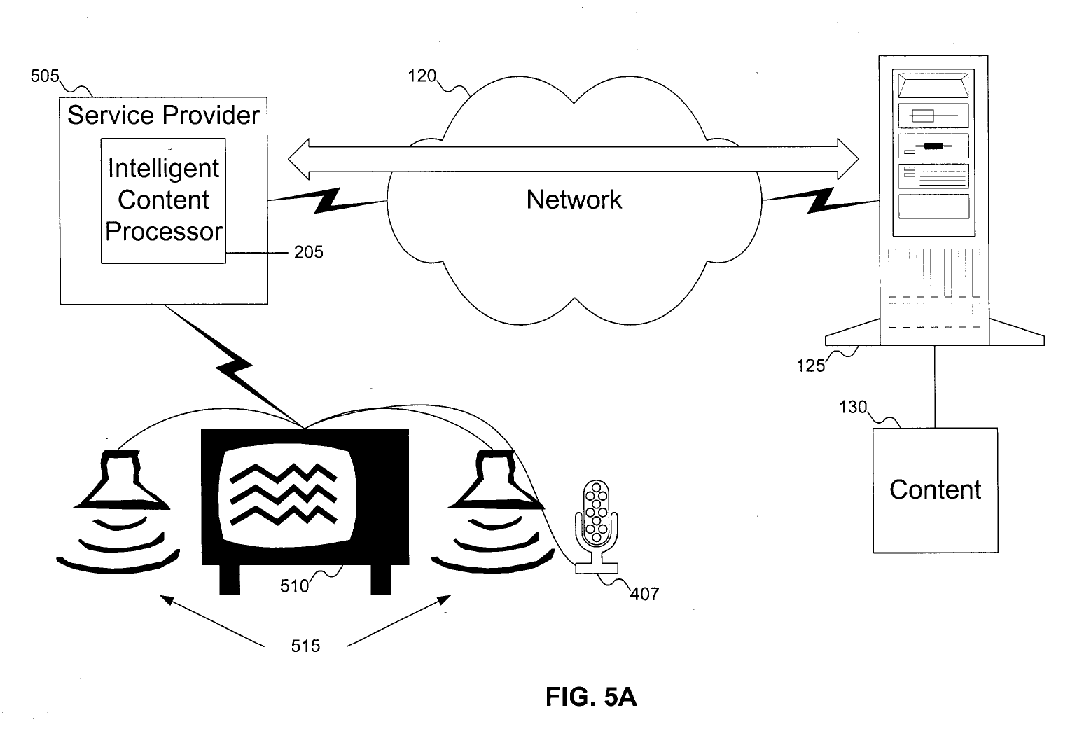

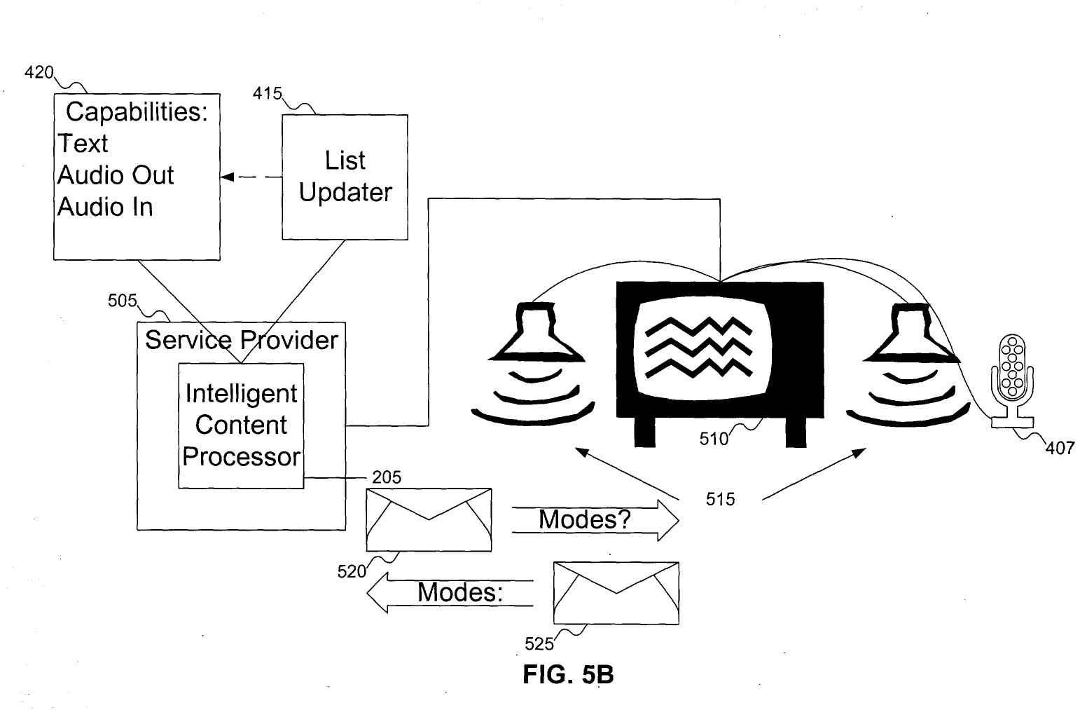

FIG. 5A shows the intelligent content processor of FIG. 2 included within a service provider, according to an embodiment of the invention. Although FIG. 5A only describes a service provider, a person skilled in the art will recognize that intelligent content processor 205 may be installed in other types of network sources. For example, intelligent content processor 205 may be installed in a content provider. The operation of intelligent content processor 205 is not altered by the type of provider in which it is installed. For variation, the user is shown interacting with the network using television 510, speakers 515, and microphone 407, providing text/graphics, video, and audio input/output.

FIG. 5B shows the intelligent content processor of FIG. 5A updating a list of capabilities supported by the client of FIG. 5A, according to an embodiment of the invention. When the user requests intelligent content provider 205 to access a source of content, intelligent content provider 205 sends query 520 to the user's system. The user's system responds with capability list 525, which list updater 415 uses to update list 420. Note that when the user disconnects from the network, intelligent content processor 205 may discard list 420.

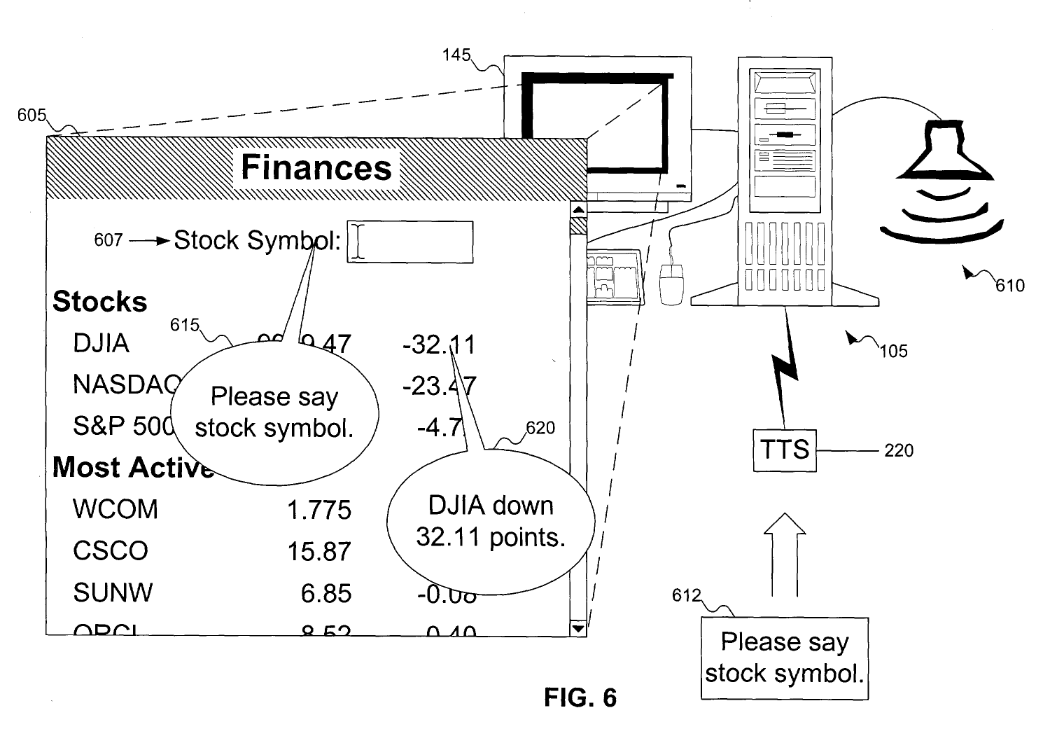

FIG. 6 shows the intelligent content processor of FIG. 2 providing content to the client of FIG. 2 in multiple modes, according to an embodiment of the invention. In FIG. 6, the user is shown browsing a web page on computer system 105. This web page is in a single mode (text and graphics), and is displayed in text and graphics on monitor 145, shown enlarged as web page 605. In the example of FIG. 6, web page 605 is displaying stock information. In particular, note that the web page includes input box 607, where a user may type in a stock symbol for particular information about a stock.

Intelligent content processor 205 (not shown in FIG. 6) determines that the web page includes input box 607, and has been informed that the user has speaker 610 as part of computer system 105. This means that computer system 105 is capable of an audio output mode. To facilitate multi-modal browsing, intelligent content processor 205 takes the text for input box 607 (shown as text 612) and uses text to speech module 220 to provide an audio prompt for input box 607 (shown as speech bubble 615). Similarly, intelligent content processor 205 may provide audio output for other content on web page 605, as shown by speech bubble 620.

FIG. 7 shows the intelligent content processor of FIG. 2 separating content into two modes and synchronizing delivery to two different devices, according to an embodiment of the invention. In FIG. 7, the client is not a single system supporting multi-modal browsing, but rather two different legacy devices, each supporting a single mode. Since intelligent content processor 205 is aware of what devices (and what modes) a client is capable of receiving content in, intelligent content processor 205 may take advantage of this information to “simulate” a multi-modal browsing experience. Intelligent content processor 205 delivers the text and graphics to the device that may receive text and graphics (in FIG. 7, computer system 105), and delivers the audio to the device that may receive audio (in FIG. 7, cellular telephone 110). This splitting and separate delivery is shown by arrows 705 and 710, respectively.

Intelligent content processor 205 also makes an effort to coordinate or synchronize the delivery of the separate channels of content. “Synchronization” in this context should not be read as suggesting a perfect synchronization, where words are precisely matched to the movement of a speaker's lips, but rather to mean that the audio content is played out over the audio channel at the same time that the corresponding video content is played out over the video channel. Thus, if the user selects to view another web page, any unplayed audio on the audio channel is terminated to synchronize the new web page's audio and video.

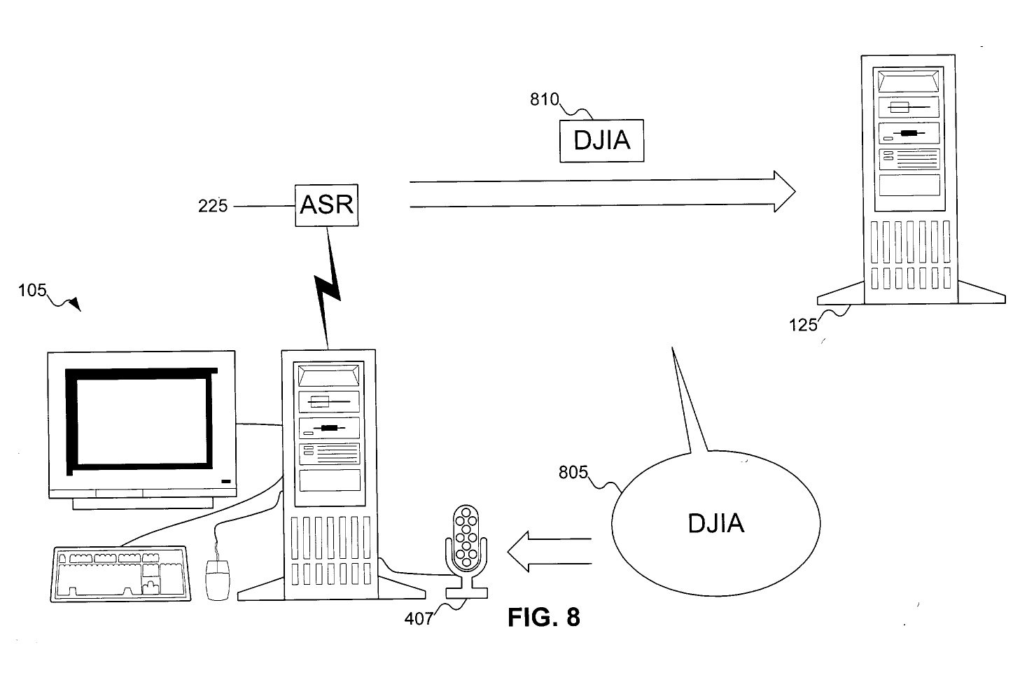

Similar to the transformation of data explained above with reference to FIG. 6, the intelligent content processor of FIG. 2 may translate data provided by the client into a different mode for the source of the content. This is shown in FIG. 8. In FIG. 8, computer system 105 includes microphone 407, meaning that computer system 105 has an audio input mode. When the user speaks his desired input into microphone 407 (shown as speech bubble 805), automatic speech recognition system 225 translates the spoken words (in FIG. 8, the acronym “DJIA”) into text 810, which may then be forwarded to the content source.

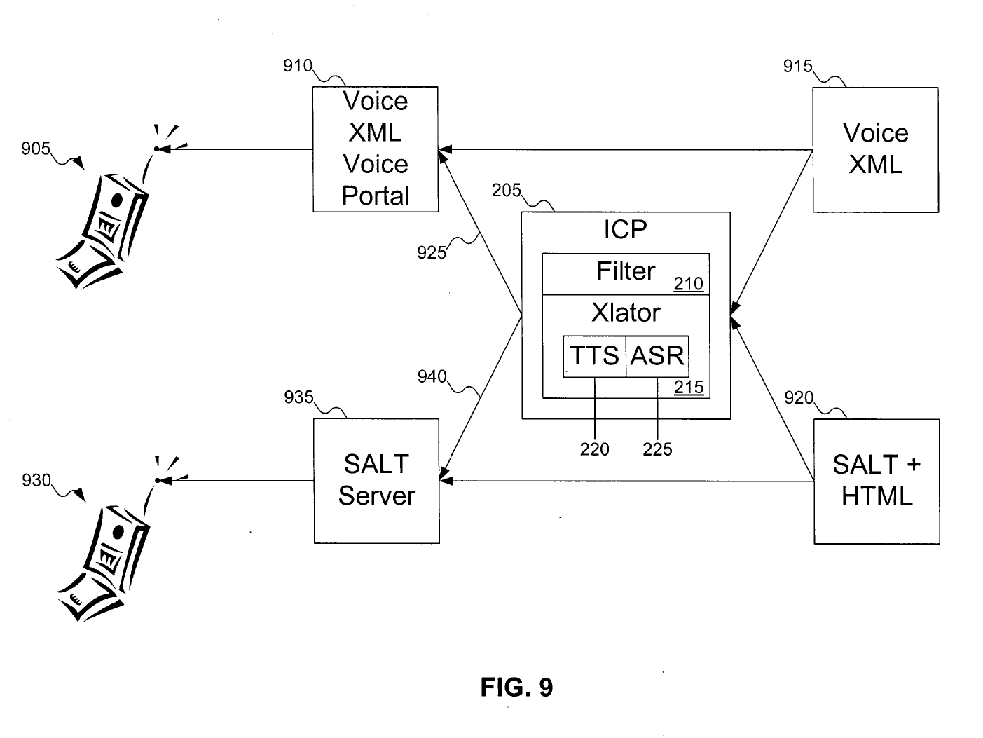

FIG. 9 shows the intelligent content processor of FIG. 2 translating content between different modes for legacy devices, according to embodiments of the invention. As discussed above, the most common types of legacy content on the Internet today are text/graphical content, accessible with a browser, and voice content, accessible with a voice telephone. Complicating matters are two competing standards for audio content over the Internet. One standard is VoiceXML, which provides for eXtensible Markup Language (XML) tags that support audio. Another standard is SALT (Speech Application Language Tags). Because these standards are not compatible with each other, a device that supports VoiceXML may not process SALT tags, and vice versa. Where a legacy device, such as a cellular telephone, depends on a particular standard for receiving content in a particular mode, intelligent content processor 205 may translate between different standards for that mode. This enables the legacy device to receive content from a source the legacy device could not normally process.

In FIG. 9, cellular telephone 905 is capable of receiving VoiceXML content, but not SALT content. Where cellular telephone 905 accesses VoiceXML voice portal 910 and requests content 915, which uses VoiceXML tags, the content may be delivered directly to VoiceXML voice portal 910, and thence to cellular telephone 905. But if cellular telephone 905 requests content 920, which uses SALT tags, intelligent content processor 205 translates the content from SALT tags to VoiceXML tags, which may then be delivered to VoiceXML voice portal 910, as shown by arrow 925.

Similarly, when cellular telephone 930, capable of receiving content using SALT tags, requests content 920 from salt server 935, the content may be delivered directly to SALT server 935, and thence to cellular telephone 930. When cellular telephone 930 requests content 915, intelligent content processor 205 translates the content from VoiceXML tags to SALT tags, which may then be delivered to SALT server 935, as shown by arrow 940.

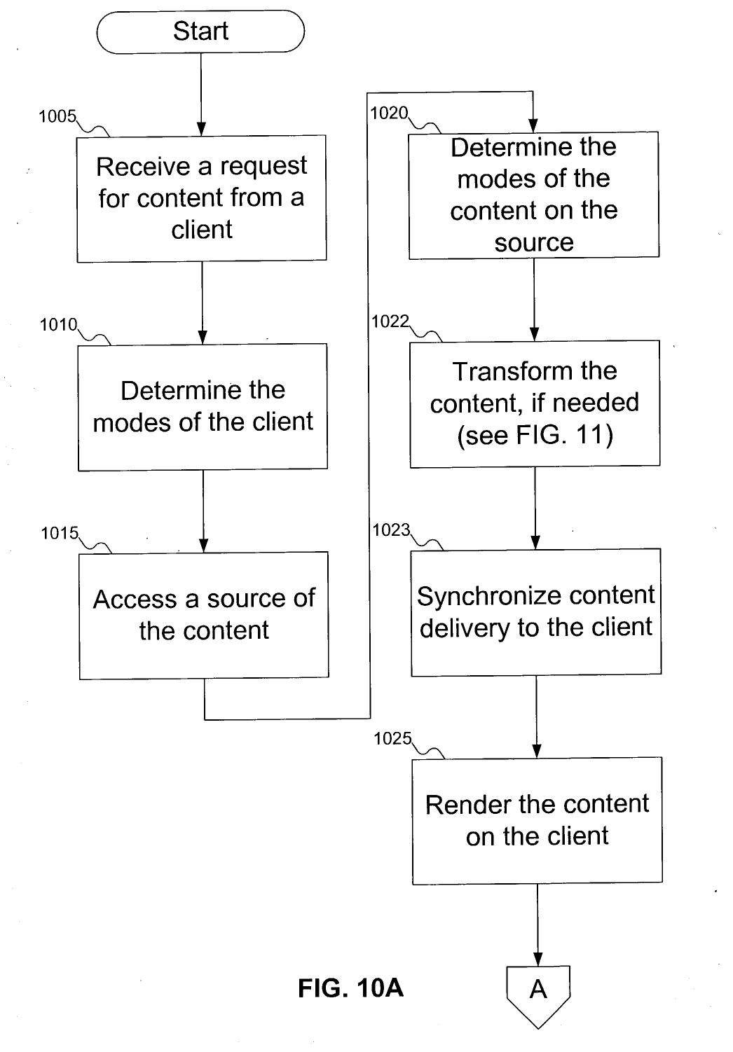

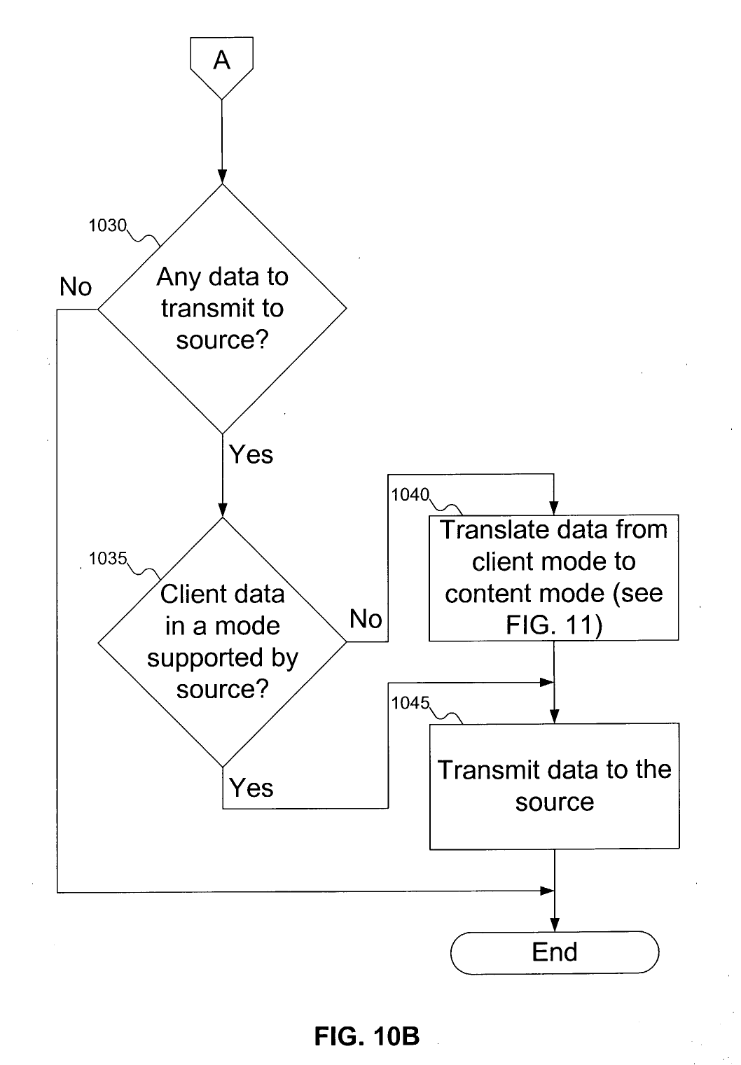

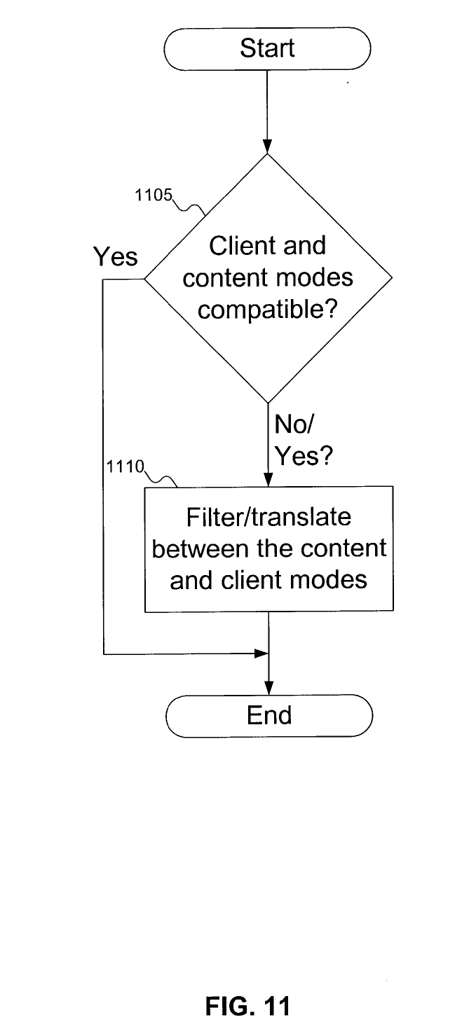

FIGS. 10A-10B show a flowchart of the procedure used by the intelligent content processor of FIG. 2 to facilitate using multiple modes, according to an embodiment of the invention. In FIG. 10A, at block 1005, the intelligent content processor receives a request for content from a client. At block 1010, the intelligent content processor determines the modes supported by the client. At block 1015, the intelligent content processor accesses a source of the desired content. Note that there may be more than one source of the content, and that different sources may support different modes. At block 1020, the intelligent content processor determines the modes supported by the source of the content. At block 1022, the intelligent content processor transforms the content, if needed. This is described further below with reference to FIG. 11. At block 1023, the content to be delivered to the client is synchronized, so that if there are multiple different devices receiving the content for the client, the devices receive related content at roughly the same time. At block 1025, the content is displayed to the user on the client.

At decision point 1030 (FIG. 10B), the intelligent content processor determines if there is any data to transmit from the client to the source. If there is, then at decision point 1035 the intelligent content processor determines if the data is in a mode supported by the source. If the data is not in a supported mode, then at block 1040 the data is transformed to a mode the source may support. Finally, at block 1045 the (possibly transformed) data is transmitted to the source, and the procedure is complete.

FIG. 11 shows a flowchart of the procedure used by the intelligent content processor of FIG. 2 to filter and/or translate content between modes, according to an embodiment of the invention. In FIG. 11, at decision point 1105, the intelligent content processor determines how if the content and client modes are completely compatible. As discussed above with reference to FIGS. 6-9, compatibility means that the client and content use the same modes and “speaking the same language” in those modes. If the client and content modes are not compatible, then at block 1110 the intelligent content processor either filters out data that is in an unsupported mode, or translates the content into a supported mode.

Note that the branch connecting decision point 1105 with block 1110 is labeled “No/Yes?”. This is because the intelligent content processor may translate content between modes even if the client and content modes are compatible. For example, referring back to FIG. 6 above, note that web page 605, which is entirely textual, is in a mode supported by computer system 105. But to enhance the browsing experience, the intelligent content processor may translate some of the content from text to audio.

A person skilled in the art will recognize that an embodiment of the invention described above may be implemented using a computer. In that case, the method is embodied as instructions that comprise a program. The program may be stored on computer-readable media, such as floppy disks, optical disks (such as compact discs), or fixed disks (such as hard drives). The program may then be executed on a computer to implement the method. A person skilled in the art will also recognize that an embodiment of the invention described above may include a computer-readable modulated carrier signal.

Having illustrated and described the principles of the invention in an embodiment thereof, it should be readily apparent to those skilled in the art that the invention may be modified in arrangement and detail without departing from such principles. All modifications coming within the spirit and scope of the accompanying claims are claimed.

1. A multi-modal browsing system, comprising:
a client;
a content source;
a network connecting the client and the content source;
an intelligent content processor coupled to the network and operative to achieve multi-modal communication between the client and the content source.

2. A multi-modal browsing system according to claim 1, wherein the client is operative to receive a content from the content source through the intelligent content processor in at least two modes in synchronization.

3. A multi-modal browsing system according to claim 1, further comprising a router installed between the client and the network, the router including the intelligent content processor.

4. A multi-modal browsing system according to claim 1, further comprising an service provider connected to the network between the client and the content source, the service provider including the intelligent content processor.

5. A multi-modal browsing system according to claim 1, wherein the intelligent content processor includes a list of modes support by the client.

6. A multi-modal browsing system according to claim 5, wherein the intelligent content processor is operative to direct content to at least two different modes supported by the client in synchronization.

7. A multi-modal browsing system according to claim 5, wherein the intelligent content processor includes a list updater to update the list of modes by interrogating the client.

8. A multi-modal browsing system according to claim 4, wherein the intelligent content processor includes a list updater to update the list of modes responsive to a message from the client that the client supports a new mode.

9. A multi-modal browsing system according to claim 1, wherein the intelligent content processor includes a translator for translating data from a first mode to a second mode.

10. A multi-modal browsing system according to claim 9, wherein the translator includes a text to speech module to generate speech from data on the content source.

11. A multi-modal browsing system according to claim 9, wherein the translator includes an automatic speech recognizer to recognize spoken words from the client.

12. A method for multi-modal browsing using an intelligent content processor, comprising:
receiving a request for content from a client;
accessing a source for the content;
determining at least a first mode on the source;
determining at least second and third modes on the client;
transforming the content from the first mode on the source to the second and third modes on the client; and
providing the content to the client.

13. A method according to claim 12, wherein the first and second modes are compatible.

14. A method according to claim 12, wherein:
determining at least a first mode on the source includes determining only the first mode on the source;
determining at least second and third modes on the client includes determining that the second mode on the client is compatible with the first mode on the source; and
transforming the content includes translating at least part of the content between the first mode on the source and the third mode on the client.

15. A method according to claim 14, wherein translating at least part of the content includes adding a voice data to a text data on the source.

16. A method according to claim 12, wherein transforming the content includes synchronizing the delivery of content in the second and third modes on the client.

17. A method according to claim 12, further comprising translating content from the client sent to the source.

18. A method according to claim 17, wherein translating content from the client includes:
performing automatic speech recognition on a voice data from the client, to identify text data; and
transmitting the text data to the source.

19. A method according to claim 12, wherein determining at least a first mode on the source includes:
requesting a list of support modes from the source; and
receiving the list of supported modes from the source.

20. A method according to claim 12, wherein determining at least second and third modes on the client includes receiving a list of supported modes from the client.

21. A method according to claim 20, wherein determining at least second and third modes on the client further includes requesting the list of supported modes from the client.

22. A method according to claim 20, wherein determining at least second and third modes on the client further includes:
receiving a new supported mode from the client; and
updating the list of supported modes to include the new supported mode.

23. A method for multi-modal browsing using an intelligent content processor, comprising:
receiving a request for content from a client;
accessing a source for the content;
determining at least a first and second mode on the source;
determining at least a third mode on the client;
translating at least part of the content from the first and second modes on the source to the third mode on the client.

24. A method according to claim 23, wherein:
the first and third modes are compatible; and
translating at least part of the content includes translating at least part of the content between second mode on the source and the third mode on the client.

25. A method according to claim 23, wherein translating at least part of the content includes translating a voice data on the source to a text data.

26. A method according to claim 23, wherein translating at least part of the content includes translating a text data on the source to a voice data.

27. A method according to claim 23, wherein transforming the content includes synchronizing the delivery of content in the second and third modes on the client.

28. A method according to claim 23, further comprising translating content from the client sent to the source.

29. A method according to claim 28, wherein translating content from the client includes:
performing automatic speech recognition on a voice data from the client, to identify text data; and
transmitting the text data to the source.

30. A method according to claim 23, wherein determining at least a first mode on the source includes:
requesting a list of support modes from the source; and
receiving the list of supported modes from the source.

31. A method according to claim 23, wherein determining at least second and third modes on the client includes receiving a list of supported modes from the client.

32. A method according to claim 31, wherein determining at least second and third modes on the client further includes requesting the list of supported modes from the client.

33. A method according to claim 31, wherein determining at least second and third modes on the client further includes:
receiving a new supported mode from the client; and
updating the list of supported modes to include the new supported mode.

34. An article comprising:
a storage medium, said storage medium having stored thereon instructions, that, when executed by a computer, result in:
receiving a request for content from a client;
accessing a source for the content;
determining at least a first mode on the source;
determining at least second and third modes on the client; and
transforming the content from the first mode on the source to the second mode on the client; and
providing the content to the client.

35. An article according to claim 34, wherein the first and second modes are compatible.

36. An article according to claim 34, wherein:
determining at least a first mode on the source includes determining only the first mode on the source;
determining at least second and third modes on the client includes determining the second mode on the client is compatible with the first mode on the source; and
transforming the content includes translating at least part of the content between the first mode on the source and the third mode on the client.

37. An article according to claim 34, wherein transforming the content includes synchronizing the delivery of content in the second and third modes on the client.

38. An article comprising a machine-accessible medium having associated data that, when accessed, results in a machine:
receiving a request for content from a client;
accessing a source for the content;
determining at least a first and second mode on the source;
determining at least a third mode on the client;
translating at least part of the content from the first and second modes on the source to the third mode on the client.

39. An article according to claim 38, wherein:
the machine-accessible medium further includes data that, when accessed by the machine, results in the machine determining that the first and second modes are compatible; and
the associated data for translating at least part of the content includes associated data for translating at least part of the content between second mode on the source and the third mode on the client.
